(19) United States
(12) Patent Application Publication
(10) Pub. No.: US 2022/0361441 A1
(43) Pub. Date: Nov. 17, 2022

(54) CATTLE GATE SYSTEM

(71) Applicant: Gary Shannon Gregory, Pleasant Shade, TN (US)

(72) Inventor: Gary Shannon Gregory, Pleasant Shade, TN (US)

(21) Appl. No.: 17/663,120

(22) Filed: May 12, 2022

Related U.S. Application Data
(60) Provisional application No. 63/187,582, filed on May 12, 2021.

(51) Int. Cl. A01K 1/06; A01K 1/00

(52) U.S. Cl. CPC A01K 1/0613; A01K 1/0017

(57) ABSTRACT

A cattle gate system having two saloon-style cattle gates. A stop system along a header of the cattle gate system enables a user to select, for each gate, which of the two swinging directions is prevented or not. Thereby, each gate may be bidirectional, unidirectional, non-directional or locked.

### CROSS-REFERENCE TO RELATED APPLICATION

This application claims the benefit of priority of U.S. provisional application No. 63/187,582, filed 12 May 2021, the contents of which are herein incorporated by reference.

### BACKGROUND OF THE INVENTION

The present invention relates to cattle gates and, more particularly, a cattle gate system that selectively enables unidirectional functionality.

Traditionally cattle gates are intended to allow the passage of vehicles through the gate, while preventing the passage of cattle or other animals.

As can be seen, there is a need for a unidirectional cattle gate system that allows cattle to pass through the cattle gates in only one direction. Thus, an animal can pass through in a first direction but will not be allowed to pass back in the opposite direction. The cattle gate system embodied in the present invention corralling cattle without the need of a person as the cattle gates can be selectively set to swing freely in a first direction, but the gates are prevented from swinging in a second direction, opposite the first direction.

Also, the present invention can also be used to only allow calves inside to a holding pen or feeding area; for instance, if the cattle farmer wants to feed his/her calves without the cows. Accordingly, the gates of the cattle gate system can be adjusted according to the size of cattle so that only smaller animals can pass through the area provided by the cattle gates.

In certain embodiments, the cattle gates can be selectively adjusted to be unidirectional or bidirectional, or wherein each of the two cattle gates as alternative directionality characteristics.

### SUMMARY OF THE INVENTION

In one aspect of the present invention, a saloon-style cattle gate system includes the following: two perimetral framing elements spaced apart and connected by a header along respective upper portions of the two perimetral framing elements; a gate pivotably connected to each perimetral framing element in such a way that the gate can swing bidirectionally relative to a vertical plane defined by the two perimetral framing elements and the header; and a stop system connected to the header, wherein the stop system comprises two stops for each gate, wherein each stop is movable between a disengaged condition and an engaged condition preventing the gate from moving from the vertical plane past the respective stop.

In another aspect of the present invention, the saloon-style cattle gate system includes wherein the two perimetral framing elements define a vertical plane, and wherein both gates are biased to occupy the vertical plane in a closed condition, wherein each stop of the pair of stops are on opposing first and second sides of the header so that a pivotability of each gate in respective first and second directions is selectively configured, wherein the header comprising an upper portion and a lower portion spaced apart, wherein each stop is removably connected to both upper and lower portions; and further including a tension spring interconnecting each perimetral framing element to the gate pivotably connected thereto so that the tension spring occupies the vertical plane in the closed condition; and a base assembly connected to respective lower portions of the two perimetral framing elements, wherein the base assembly comprises two a base member extending between the two perimetral framing elements; and a foot portion for each perimetral framing element, wherein the foot portion extends in a direction orthogonal relative to the base member, wherein a vertical area is defined by the two perimetral framing elements, the header, and the base member, wherein the vertical area approximately five and a half feet by six and a half feet.

In yet another aspect of the present invention, a method of autonomously corralling an animal in a first space includes the following: providing the above-mentioned saloon-style cattle gate system; selectively moving the stops on the second side of the header to their engaged conditions; selectively moving the stops on the first side of the header to their disengaged conditions; and installing the base assembly between the first space and an external environment, wherein the first side of the header faces the first space.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention.

FIG. 2 is a detailed rear perspective view of an exemplary embodiment of the present invention.

FIG. 3 is a detailed front elevation view of an exemplary embodiment of the present invention.

FIG. 4 is a front perspective view of an exemplary embodiment of the present invention, illustrating the gates moving in a first direction, but where the stops 18 prevent the gates from moving in the second direction.

FIG. 5 is an exploded perspective view of an exemplary embodiment of the present invention.

FIG. 6 is a top plan view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a cattle gate system having two saloon-style cattle gates. A stop system along a header of the cattle gate system enables a user to select, for each gate, which of the two swinging directions is prevented or not.

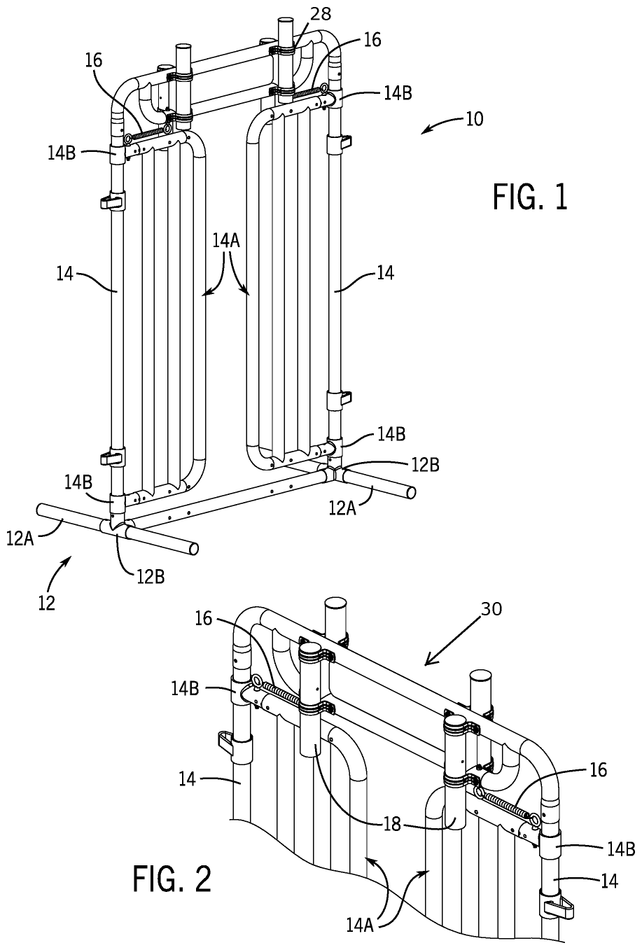

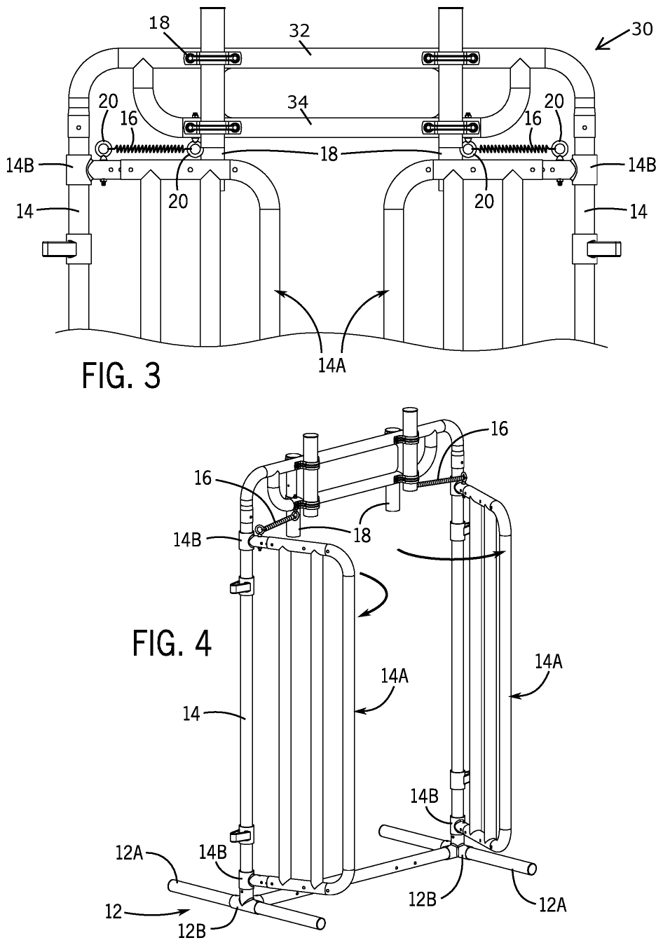

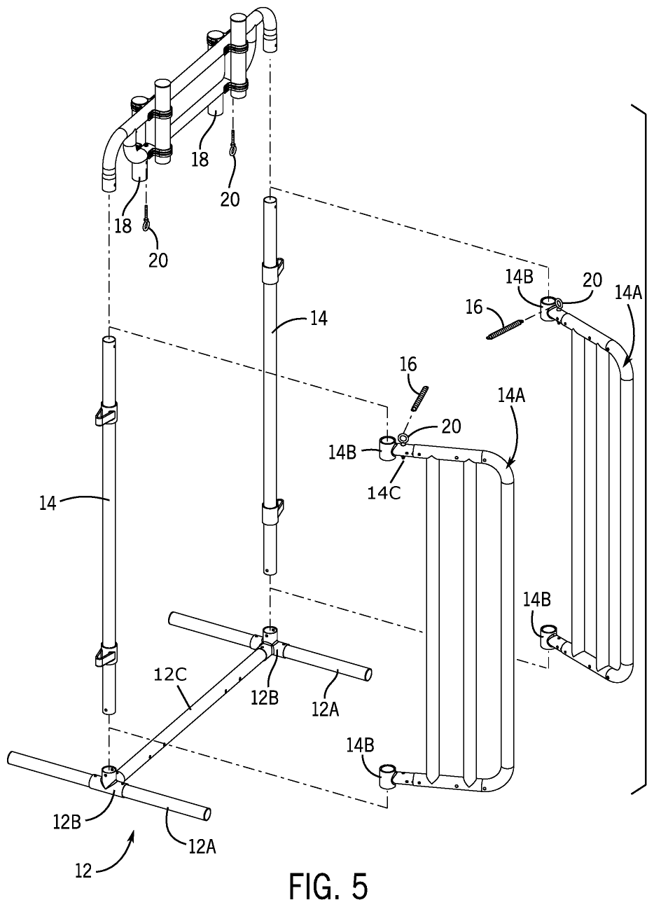

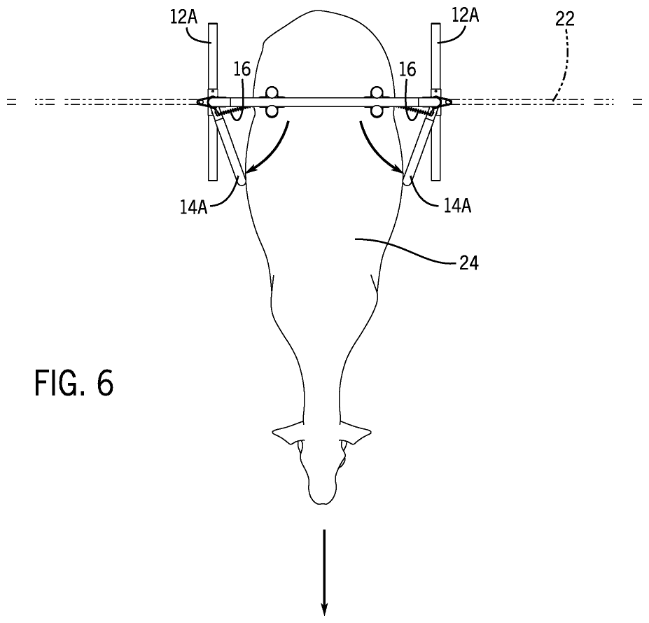

Referring now to FIGS. 1 through 6, the present invention may include a cattle gate system 10. The cattle gate system 10 may include perimetral framing elements 14. The perimetral framing elements 14 may be employed vertically, as illustrated in the Figures; though not shown in the Figures, the perimetral framing elements 14 may be selectively telescopic so that different operable vertical distances (e.g., height, elevations, etc.) may be employed, if so desired, without changing the functionality disclosed herein.

The perimetral framing elements 14 may be spaced apart and supported on a supporting surface by way of a base assembly 12. The base assembly 12 may be dimensioned and adapted to support each perimetral framing element 14 in an upright, vertical manner. In some embodiments, the base assembly 12 may include a base member 12C extending between the spaced apart perimetral framing elements 14. The base assembly 12 may include a foot portion 12A extending in a direction orthogonal relative to the base member 12C. An interconnector 12B may interconnect each foot portion 12A to opposing ends of the base member 12C. Each interconnector 12B may also interconnect a proximal end of an associated perimetral framing element 14. Thus, the interconnector 12B may be a three-way elbow or the like.

A gate 14A may be pivotably attached to each perimetral framing element 14 so that it can swing in and out of a vertical plane defined by the perimetral framing elements 14. A pivotable connection 14B may attach each arm portion 14C of the gate 14A to the associated perimetral framing element 14. The pivotable connection may be, but is not limited to, a hinge.

A header 30 may span between the upper, distal portions of the perimetral framing elements 14. The header 30 may provide an upper portion 32 and a lower portion 34 that are spaced apart from each other. Extending between the upper and lower portions 32 and 34 may be four stops 18, two stops 18 per gate 14A. Each stop 18 may extendable beyond the lower portion 34 to intersect with the silhouette profile of the respective gate 14A, wherein the presence of the stop 18 prevents the gate 14A from swinging past the stop 18. Thus, if the stops 18 are located (in an engaged condition) on a second side of the header 30, then the gates 14A can swing in the first direction away from the second side, but the gates 14A cannot swing past the stops 18 going in a second direction opposite the first direction. As a result, the gates 14A are unidirectional, so that animals 24 can push past the gate 14A in the first direction but not in the second direction. As a corollary, the animal 24 would be allowed into a first area 22, such as a holding pen, that is in the first direction of the unidirectional cattle gate 10, but the animal 24 would not be able to use the unidirectional cattle gate 10 to leave the first area 22, assuming the gates 14A are in the closed condition.

In certain embodiments, each side of the header 30 may have adjustable stops 18 so that a user may selectively determine which direction the respective gate 14A is allowed to swing. For instance, the user may move the stops 18 on the first side to an engaged condition so that the gates 14A cannot move in the first direction but are free to open in the second direction. Likewise, the user may move the stops 18 on the first side to a disengaged condition, while moving stops 18 on the second side to the engaged condition, preventing the gate from moving in the second direction as mentioned previously. Furthermore, the user may move both stops 18 on each side to the disengaged condition so that the cattle gate 10 acts bidirectionally. Finally, the user may move both sets of stops 18 to the engaged condition, locking the cattle gate 10 in both directions.

The adjustable stops 18 may be removable connected to each of the upper and lower portions 32 and 34 of the header 30 by way of clamps 28, which can be tightened or loosened so that the user may selectively move each stop between the engaged and disengaged conditions. It stands to reason, that the user may also move stops 18 associated with one of the gates 14A to the disengaged condition for a certain side, while the stops 18 associated with the opposing gate 14A, for said side, be in the engaged condition. In sum, the present invention contemplates alternatively stop settings for each gate 14A so that directionality can be selected on separately for each gate 14A. Thus one gate 14A could be unidirectionally while the other gate 14A bidirectionally movable.

A tension spring 16 or the like may connect each gate 14A to the header 30, thereby biasing each gate 14A in a closed condition—i.e., the gates 14A are in the vertical plane defined by the perimetral framing elements 14. Accordingly, urging against a gate 14A in the first direction, such as the animal 24 pushing against it, will cause it to swing in the first direction; thereafter, the biasing effect of the tension spring 16 urges the gate 14A back to the closed condition. The tension spring 16 may extend from an upper portion of the gate 14A to a lower portion 34 of the header 30. A fastener 20, such as an eyelet, may connect the tension spring 16 to the gate 14A and the lower portion 34.

In certain embodiments, the perimetral framing elements 14 may stand approximately five and a half feet tall. Though in other embodiments, the perimetral framing elements 14 may stand more or less in the vertical direction. For instance, if an animal caretaker only wants smaller animals to access the cattle gate system 10, thus preventing larger animals from moving through the cattle gate system 10 even in the first direction as the larger animals 24 would not fit through the area defined by the perimetral framing elements 14 and the header 30.

The elements and members disclosed herein may be made from galvanized tubing. The arm portions 14C may have the gate-connected fastener 20 for the spring 16. Likewise, the header-connected fastener 20 for the same spring 16 may be disposed in the vertical plane in the closed condition. In other words, the fasteners 20 extend vertically from their respective connection points on the gate 14A and the header 30. This way, the spring 16 is in the center and top of frame, whereby the spring 16 acts as a component that will allow the movement of doors to swing in and to also swing out. The springs 16 enable the self-correcting “home” position of a saloon style door. The two gates 14A do not touch when they are moving and in the saloon door “home” position. The two gates 14A can be as far as sixteen inches apart from the other. This allows the cattle a more enticing reason to go through the corralled area.

This cattle gate system 10 can be used every day in the field and operated by cattle 24. The cattle 24 can and will create the habit of utilizing the mechanics daily once the cattle gate system 10 is set up. And so, if a cattle farmer has trouble herding his cattle because of the nature of the cattle, or he/she has limited help or time, this cattle gate system 10 works by itself. The cattle farmer can set up the cattle gate 10 communicating to their coral panels and let cattle use it every day, going in and out of holding or feeding area. The day or days that the cattle need to be contained, the doors can be set to only open into the holding pen/coral panel area 22.

Also, the cattle gate 10 can also be used to only allow calves inside to holding pen or feeding area. If the cattle farmer wants to feed his/her calves without the cows, the gates 14A can be adjusted through, in part, the telescopic functionality of the frame elements 14 and gates 14A. Also, insecticide rubs can be added to the cattle gate 10 for fly season.

As used in this application, the term “about” or “approximately” refers to a range of values within plus or minus 10% of the specified number. And the term “substantially” refers to up to 90% or more of an entirety. Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A saloon-style cattle gate system, the system comprising:
two perimetral framing elements spaced apart and connected by a header along respective upper portions of the two perimetral framing elements;
a gate pivotably connected to each perimetral framing element in such a way that the gate can swing bidirectionally relative to a vertical plane defined by the two perimetral framing elements and the header; and
a stop system connected to the header, wherein the stop system comprises two pairs of stops, one pair of the two pairs of stops for each gate, wherein each stop is movable between a disengaged condition and an engaged condition preventing the gate from moving from the vertical plane past the respective stop.

2. The system of claim 1, wherein the two perimetral framing elements define a vertical plane, and wherein both gates are biased to occupy the vertical plane in a closed condition.

3. The system of claim 2, wherein each stop of the pair of stops are on opposing first and second sides of the header so that a pivotability of each gate in respective first and second directions is selectively configured.

4. The system of claim 3, wherein the header comprising an upper portion and a lower portion spaced apart.

5. The system of claim 4, wherein each stop is removably connected to both upper and lower portions.

6. The system of claim 5, further comprising a tension spring interconnecting each perimetral framing element to the gate pivotably connected thereto so that the tension spring occupies the vertical plane in the closed condition.

7. The system of claim 6, further comprising a base assembly connected to respective lower portions of the two perimetral framing elements, wherein the base assembly comprises two a base member extending between the two perimetral framing elements; and a foot portion for each perimetral framing element, wherein the foot portion extends in a direction orthogonal relative to the base member.

8. The system of claim 7, wherein a vertical area is defined by the two perimetral framing elements, the header, and the base member, wherein the vertical area approximately five and a half feet by six and a half feet.

9. A method of autonomously corralling an animal in a first space, the method comprising:
providing the system of claim 7;
selectively moving the stops on the second side of the header to their engaged conditions;
selectively moving the stops on the first side of the header to their disengaged conditions; and
installing the base assembly between the first space and an external environment, wherein the first side of the header faces the first space.
